(19) United States
(12) Patent Application Publication
(10) Pub. No.: US 2025/0214907 A1
(43) Pub. Date: Jul. 3, 2025

(54) COMPOSITION AND METHOD USING PARAFFINIC MINERAL OIL TO IMPROVE AGRICULTURAL CROP GROWTH AND YIELD

(71) Applicant: TSS Data Resources, LLC, Gilroy, CA (US)

(72) Inventors: John R. Washington, Ocala, FL (US); Jerald E. Wheeler, Tucson, AZ (US); Ziad Tadros, Pinehurst, NC (US); Dean C. Storkan, Lake Forest, IL (US)

(21) Appl. No.: 19/007,512

(22) Filed: Jan. 1, 2025

Related U.S. Application Data
(60) Provisional application No. 63/616,993, filed on Jan. 2, 2024.

(51) Int. Cl. C05F 11/00; C05G 3/00

(52) U.S. Cl. CPC C05F 11/00; C05G 3/00

(57) ABSTRACT

A biofertilizer comprised of formulated mixtures of paraffinic mineral oil (PMO), additional and specific hydrocarbons of varied molecular structure and number of carbons, together with specialized chelated metals, soil-inhabiting bacteria, and an emulsifying agent are applied to agricultural soil or other growing media to increase crop health, growth, and yield as well as the prevention of plant disease and postharvest diseases. The biofertilizer formulations may be applied in mixtures with water to the soil or other plant growth substrate, or in combination with various other soil amendments, fumigants, fertilizers, microbes, and crop growth stimulants and may be applied in various formulations and using various means of application. The described biofertilizer stimulate the population of plant growth promoting bacteria (PGPR) and other beneficial microorganisms including bacteria and fungi, which in turn, which increases crop growth and yield.

### FIELD OF THE INVENTION

This invention relates to the formulation of a biofertilizer comprised of paraffinic mineral oil and other liquid hydrocarbons of varying molecular structure and number of carbons together with metal-chelating agents and microbes and applied to agricultural soil or other plant growth media in order to improve crop growth and yield by increasing the population of plant growth-promoting bacteria (PGPR) in the plant growth medium.

### BACKGROUND OF THE INVENTION

Soil microbial communities are known to influence crop outcomes such as yield and quality, tolerance of plants to environmental stresses such as drought and high temperatures, plant susceptibility to pests and diseases, and overall productivity and efficiency of crop production including profitability and sustainability. Soil microbes, including fungi and bacteria play determinative roles in sustainable crop production. They mediate key soil processes such as nutrient mobilization and uptake by plants, degradation of soil organic matter and plant growth-promoting effects in the rhizosphere. Furthermore, soil microbes that are antagonistic toward plant-pathogenic fungi and bacteria can decrease the incidence and severity of plant disease.

Improved sustainability practices and less reliance on synthetic chemical fertilizers and pesticides have been and continue to be major objectives for the agricultural industry worldwide. We have determined that agricultural sustainability may be enhanced and significant positive economic impacts for farmers may be realized by identifying and implementing specific, non-pesticidal, and economically viable inputs to improve microbial soil health and, by extension, crop health and productivity. This technology is directly relevant to increasing the capacity of the soil to sequester and store carbon in the soil and increasing other microbially mediated processes such as nitrogen fixation, potassium and phosphorous cycling, and micronutrient uptake by plants. Furthermore, additional effects include the increase in populations of plant growth-promoting rhizobacteria (PGPR).

It is commonly understood that agricultural soil contains many species of microorganisms, such as bacteria and fungi. Plant growth-promoting rhizo bacteria (PGPR) as well as plant growth-promoting fungi are highly concentrated in the rhizosphere, a region of the soil surrounding plant roots. It is also understood that these PGPR organisms significantly stimulate and promote plant growth both directly and indirectly. PGPR provide nutrients to host plants and produce phytohormones that regulate plant growth and metabolic activity. PGPR also inhibit and control pathogens, which better protects plant hosts against diseases and abiotic stress, These microorganisms likewise improve soil fertility and soil health. Specific plant growth-promoting activities of PGPR include increased plant root growth, microbially-mediated nitrogen fixation, phosphate and potassium solubilization, indoleacetic acid and pyrroloquinoline quinone biosynthesis, siderophore transport, induction of systemic induced plant resistance and interference with plant pathogen attack.

To date, no proven, economical means has been developed to increase the presence of PGPR in the crop root zone by inducing measurable, major shifts in the soil biome using a powerful carbon source combined with metal-chelating agents. These chemical components are applied in a crop-specific manner and are completely compatible with the most prevalent agricultural operations in the world today. We have determined that a significant need exists for such a process, as well as for a technique that effectively addresses and overcomes the limitations and challenges associated with conventional attempts to improve crop production including synthetic fertilizers and pesticides.

### SUMMARY OF THE INVENTION

It is therefore an object of the present invention to provide a method of increasing the population of PGPR and other crop beneficial microorganisms in the rhizosphere of plants in an agricultural soil or other growing media so that increased crop growth and yield are achieved.

It is a further object of this invention to provide a method for improving agricultural crop growth and yield that reduces the expense with using chemical fertilizers on an agricultural planting site.

It is a further object of this invention to provide a method for improving agricultural crop growth and yield which effectively increases carbon sequestration and storage in the soil.

It is a further object of this invention to provide a method for improving agricultural crop growth and yield without encountering the expense and difficulties of scale involved with adding organic amendments to the soil at high use rates.

It is a further object of this invention to provide a biofertilizer comprised of paraffinic mineral oil together with other liquid hydrocarbons that may be applied in various ways and coapplied with various other components including, but not limited to, soil microbes, plant fertilizers, bio-stimulants, micronutrients, metal chelating agents, surfactants, and emulsifying agents in order to effectively increase plant growth and yield and reduce plant disease including post-harvest disease.

It is a further object of the present invention to provide a biofertilizer to the soil or other growing medium comprised of the described formulations which when applied at application rates between 0.5-5.0 gallons per acre increases crop growth and yield in agricultural production systems.

It is a further object of this invention to provide a biofertilizer formulation which includes beneficial paraffinic mineral oil and an emulsifying agent, which improves the availability and dispersion of the paraffinic mineral oil into the plant root zone.

It is a further object of the invention to provide specific application methods of the biofertilizer to the plant growing medium including open field soil, artificial growing media, and hydroponic growing systems.

It is a further object of the invention to increase plant root growth by applying the biofertilizer to the soil or other growing media in mixtures with water or injected into irrigation systems.

It is a further object of the invention to increase the population of PGPR microorganisms within the plant root zone in the soil or growing medium by applying the biofertilizer which is an easily degradable food source for the native (already present) microorganisms beneficial to plant growth and health.

It is a further object of the invention to combine the biofertilizer with plant fertilizers and bio-stimulants, specialized liquid hydrocarbon mixtures, strong metal-chelating agents, nutrients for microorganisms, additional surfactants, emulsifiers, and prepared inoculum of soil microbes in specialized formulations for specific crops and growing systems.

It is a further object of the invention to co-apply the biofertilizer with the soil fumigants chloropicrin, 1,3-dicloropropene, and dimethyl disulfide as preplant treatments for crops.

This invention results from a realization that significantly improved crop growth and yield is achieved in an agricultural planting site by applying a biofertilizer formulation that includes paraffinic mineral oil (PMO), other liquid hydrocarbons of varying molecular structure and carbon number, alone or in combination with metal chelating agents, soil microbes. surfactants, emulsifiers, and preplant soil fumigants.

This invention features a method of applying the biofertilizer to the soil or other agricultural growing medium of an agricultural planting site. The biofertilizer is applied either by itself or in combination (i.e., co-applied) with one or more other described components. The biofertilizer is applied at a rate of between 0.5-5 gallons per acre of planting site.

In a preferred embodiment, the biofertilizer is applied as a formulated suspension of liquid hydrocarbons and the other described components in water or without water. The biofertilizer may be applied as an oil in water emulsion wherein an emulsifier is used at a rate of 1-5% of the liquid hydrocarbon volume. The ratio of oil and water in the biofertilizer formulation can vary widely. The applied biofertilizer may be formulated in an organic or mineral matrix absorbed onto a substrate such as vermiculite, perlite, carboxy methyl cellulose or any organic or inorganic material that will hold or complex the biofertilizer. Furthermore, the biofertilizer formulation can be applied in the form of pellets, gel, solid granules, beads, slurry, viscous liquid or treated compost. The biofertilizer may also be formulated into solid and/or liquid fertilizers, with soil fumigants and soil or growth medium amendments. The biofertilizer may also be formulated and co-applied with PGPR and other growth promoting microorganisms, metal-chelating agents, bio-stimulants, and other active ingredient which increase population growth of beneficial soil microbes.

The biofertilizer may be applied to soil or various other forms of growing media. Such growing media may include, but is not limited to, peat, coir, pine bark, vermiculite, sand, pumice, lava, gravel, perlite, expanded shale, rock wool, field soil and mixtures or combinations of the foregoing.

The biofertilizer may be applied to the soil or other growing media by various application methods known in the agricultural industry. These include, but are not limited to, drip irrigation systems, overhead irrigation systems, applied as lay by or side dress, or in furrow application, applied with agricultural implements, applied by spraying (preplant or post plant) over the soil and plants, applied by soil subsurface knifing, or injection. The biofertilizer may be sprayed onto soil or crops and washed in with irrigation water, co-applied with preplant soil fumigants, either simultaneously or sequentially, and co-applied with a fertilizer, organic soil or mineral matrices.

### BRIEF DESCRIPTION OF THE DRAWINGS

FIG. 1A is a photograph depicting two side by side sets of Anaheim pepper plants fifteen days after planting; the righthand set was untreated and the lefthand set was treated at a rate of one-half gallon of the biofertilizer per acre;

FIG. 1B is a photograph of two additional side by side sets of Anaheim pepper plants fifteen days after planting; the righthand set was treated at a rate of one gallon the biofertilizer per acre and the lefthand set was treated at a rate of two gallons of the biofertilizer per acre;

FIGS. 2A-2C are photographs of three sets of pepper plants fourteen days after planting and respectively depicting untreated plants and plants treated in accordance with this invention at a rate of two gallons of the biofertilizer per acre and three gallons the biofertilizer per acre respectively; and

FIG. 3 is a graph illustrating the total bacterial genome comprised of PGPR and nutrient solubilizing bacteria in soil supporting tomato plants and indicating the respective rhizosphere population levels of such bacteria for untreated plants and plants treated at respective rates of one, two and four gallons of the biofertilizer per acre.

### DETAILED DESCRIPTION OF PREFERRED EMBODIMENTS

Agricultural plant growth and yield are significantly increased and improved by applying a biofertilizer comprised of mineral oil (PMO) and other liquid hydrocarbons together with metal chelates, beneficial soil microbes, surfactants, and emulsifiers to an agricultural soil or other plant growing media. It should be understood that the biofertilizer and the application methods disclosed herein are beneficial for all types of agricultural soil and growing media. As used herein, “growing media” encompasses agricultural soil and all other types of plant growth media in which crops and plants may be planted and grown. These include but are not necessarily limited to peat, coir, pine bark, vermiculite, sand, pumice, lava, gravel, perlite, expanded shale, rock wood, open field soil, artificial growing media, hydroponic growing systems and various mixtures and combinations of the foregoing. The particular type of soil or other growing media involved is not a limitation of this invention. Moreover, the formulation and method of this invention may be employed to improve crop production in virtually all types and sizes of agricultural planting sites including indoor and outdoor sites, greenhouses, hydroponic sites, greenhouse growing media, growing containers and agricultural fields of all sizes and configurations. The invention may be practiced in virtually all agricultural venues and locations.

In certain preferred embodiments, the biofertilizer is suspended in an oil-in-water-emulsion or an emulsion without water. A preferred concentration is 50-95% hydrocarbons, an emulsifying agent comprising 5% of the hydrocarbon volume, and with or without water. Such concentration may be on either a weight/weight or volume/volume basis. The emulsion may also include additional ingredients such as essential plant nutrients, microbial nutrients, metal-chelating compounds, plant-active hormones, soil microbes, any liquid hydrocarbon, and any additional active ingredient beneficial to plant growth. Various commercially available, proprietary, or formulated emulsifiers may be employed.

The biofertilizer may be formulated to include beneficial microbes such as bacteria and fungi. A particularly preferred fungal additive is Trichoderma, a well-established biological control agent, antibiotic producer and plant root endophyte. Bacterial additives may include the genera Bacillus, Pseudomonas, Sphingomonas, or other PGPR or otherwise valuable bacterial species.

In some formulations, the biofertilizer may be employed by itself in liquid form and applied by soil drench, injected into irrigation systems, knifed into soil, or sprayed over the crops and/or soil or growing medium. Alternatively, the biofertilizer may be formulated in an organic matrix, inorganic/mineral matrix, pellets, gel, fertilizer granules, viscous liquid, beads or slurry, or with compost or an absorbent material. In particular, the biofertilizer may be absorbed onto a substrate comprising vermiculite, perlite, carboxy methyl cellulose or other organic/inorganic material capable of hosting or complexing the biofertilizer formulation components.

Field applications of the biofertilizer usually employ liquid hydrocarbon mixtures emulsified in water or without water. Emulsification improves the availability and dispersion of biofertilizer into the plant root zone and thereby enhancing its beneficial effects including the resulting beneficial increase in population of the PGPR. When the biofertilizer is suspended in water, an emulsifying agent is used. A preferred formulation for emulsified biofertilizer to be applied in accordance with this invention is 50-100% liquid hydrocarbons, and 1-5% emulsifier relative to the liquid hydrocarbon component. Additional constituents as described above may be used and the concentrations adjusted accordingly. The beneficial results described more fully below are best achieved when the biofertilizer is applied at a rate of 0.5 to 5 gallons per acre. Acceptable and especially efficient growth and yield results are achieved when biofertilizer is applied between 1 and 2 gallons per acre on a monthly basis.

The biofertilizer may be applied by any of the following known agricultural application methods:
(a) drip and tarp irrigation system;
(b) lay by or side dress application;
(c) In furrow application;
(d) oil and water emulsion;
(e) liquid drench
(f) sprayed over soil pre or post plant;
(g) optionally incorporated (mixed) with soil or growing medium;
(h) knifed in, injected or otherwise applied subsoil at various depths;
(i) sprayed onto plants and washed in with irrigation water;
(j) applied with preplant soil fumigants, e.g., chloropicrin, Telone, Metam, MITC, DMDS and 1,3 dichloropropene. The biofertilizer may be mixed with the fumigant and applied simultaneously or applied separately either before or after the fumigant.
(k) complexed with fertilizer, organic or mineral matrix.

In applications where the biofertilizer is mixed or otherwise applied with a fumigant, the PMO has a total concentration of between 1-50% of the applied fumigant on a weight/weight basis.

A preferred metal-chelating agent is Fe HBED (hydroxybenzyl ethylenediamine), or Iron HBED. Microorganisms compete for iron in the soil. HBED is a very strong chelating agent for iron and other metals, and it is known that PGPR bacteria can sequester/obtain iron from Fe HBED, whereas plant-pathogenic bacteria and most bacteria in general cannot. Thus, the application of Fe HBED in the soil favors the growth and proliferation of beneficial bacteria such as PGPR and consequently the PGPR will outcompete other less beneficial, or harmful/pathogenic bacteria. The biofertilizer hydrocarbon components plus Fe HBED appears to have a synergistic or at least an additive effect. The effective application rates of the Fe HBED and the sodium or potassium salt of HBED (Na HBED or K HBED) to the soil at rates ranging from 10 grams-2 kilograms per acre, mixed in with the other described components of the biofertilizer.

The biofertilizer as disclosed herein is applied to various plant growing medium including open field soil, artificial growing media, hydroponic growing systems and as otherwise stated herein to dramatically increase plant growth including roots. The biofertilizer formulations as disclosed herein significantly increase the population of PGPR within the plant's root zone. This is accomplished because the biofertilizer is an easily degradable food source for the native or introduced PGPR. The population of such beneficial microorganisms increases rapidly and dramatically and, in turn, growth and yield benefits as well as reduction in plant disease are provided to the crops where the biofertilizer is applied.

We have also determined that the application of the biofertilizer to the soil or other growing media likewise serves as a beneficial food source for the Trichoderma fungus. This fungus is known to be an effective bio-control agent in the soil, which combats fungal pathogens including Pythium and Phytophthora. The percent of fungal population comprised of Trichoderma in an agricultural soil or other plant growth medium increases substantially after application of the biofertilizer at a rate of 0.5-5 gallons per acre.

The following examples illustrate the benefits achieved by applying the biofertilizer to an agricultural planting site according to this invention.

### Example 1

Table 1 reflects the results of Anaheim pepper seedlings which are both untreated and treated with various rates of the formulated biofertilizer in accordance with this invention.

TABLE 1
Table 1. Plant growth 15 days after planting Anaheim pepper
(Capsicum annuum) seedlings (3-4 leaf stage) in farm
soil treated with various rates of the biofertilizer.

| | | | | Mean | Mean | Mean |
|---|---|---|---|---|---|---|
| | | Mean | Mean | fresh | fresh | total |
| Rate per | | shoot | root | weight of | root | plant |
| Acre | Total | length | length | shoots | weight | weight |
| (gallons) | Plants | (inches) | (inches) | (grams) | (grams) | (grams) |
| Non-treated | 10 | 9.6 | 2.9 | 3.0 | 0.6 | 3.6 |
| Check | | | | | | |
| 0.5 | 10 | 10.0 | 4.2 | 4.2 | 1.2 | 5.4 |
| 1.0 | 10 | 15.2 | 9.0 | 9.0 | 5.0 | 14.0 |
| 2.0 | 10 | 14.9 | 8.2 | 8.2 | 3.5 | 11.7 |
| 3.0 | 10 | 15.1 | 9.0 | 9.0 | 4.2 | 132 |
| 4.0 | 10 | 15.0 | 8.9 | 8.9 | 4.4 | 13.3 |

Each of the growth measurements for the treated plants, which were treated at rates of 0.5-4.0 gallons per acre, is significantly greater than the measured results for the untreated plants. In this example, optimal plant growth benefits appear to apply at a rate of 1 gallon per acre of the biofertilizer.

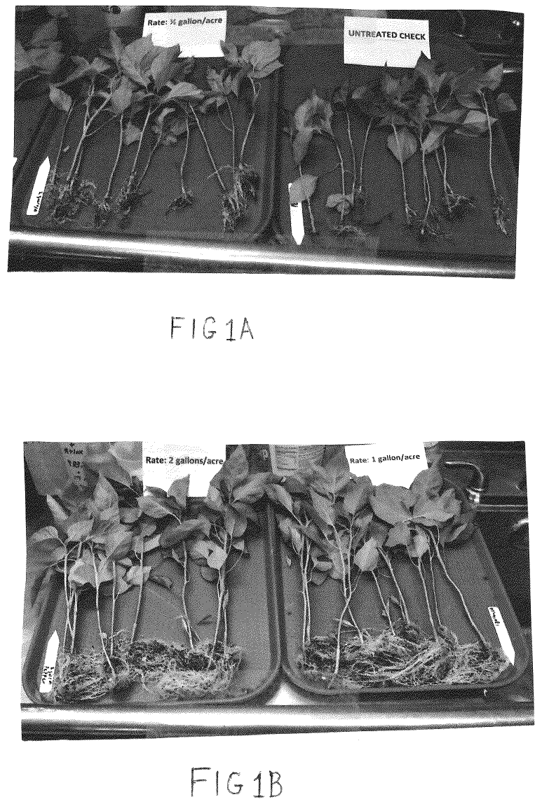

FIGS. 1A and 1B depict the Anaheim pepper plants after fifteen days in accordance with the foregoing table. As shown in FIG. 1A} the root structure of the plants that were untreated (righthand set) and treated with only one half gallon of the biofertilizer (lefthand set) are significantly smaller than the roots of the plants shown in FIG. 1B, wherein the righthand set of plants were treated at a rate of one gallon per acre of the biofertilizer and the lefthand set were treated at a rate of two gallons of the biofertilizer per acre. These photographs validate the measurements of length and weight of the respective untreated and treated plants reflected in Table 1.

### Example 2

TABLE 2
Table 2. Tomato “Roma” plant growth measured
at 14 days following application of the formulated
biofertilizer to soil in the greenhouse.

| | | | | | | Mean |
|---|---|---|---|---|---|---|
| Treatment | | Mean | Mean | Mean | Mean | total |
| Rate | | shoot | root | shoot | root | plant |
| (gallons/ | Total | length | length | length | weight | weight |
| acre) | Plants | (inches) | (inches) | (grams) | (grams) | (grams) |
| Nontreated | 10 | 4.7 | 11.6 | 2.5 | | 11.8 |
| Check | | | | | | |
| 2.0 | 10 | 8.3 | 14.4 | 4.0 | 13.6 | 17.6 |
| 4.0 | 10 | 10.1 | 14.8 | 3.7 | 14.8 | 18.5 |

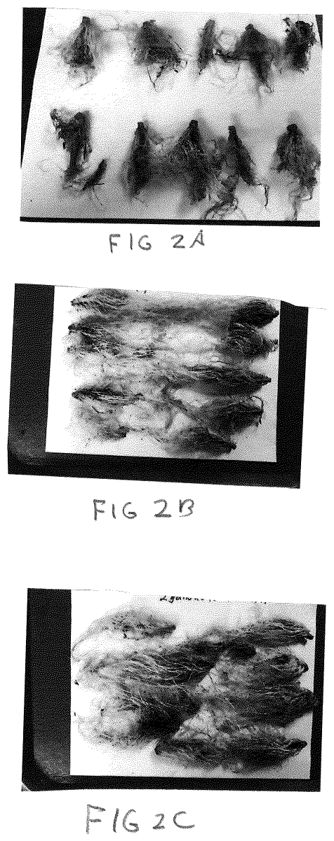

As shown in Table 2 and FIGS. 2A, 2B and 2C, the biofertilizer was applied to tomato plants at rates of 2 gallons per acre and 4 gallons per acre and the measured results were compared against the results from untreated plants, In this example, the treated plants, FIG. 2B (2 gallons per acre) and FIG. 2C (4 gallons per acre) again exhibited much greater plant growth results at fourteen days than the untreated plants, FIG. 2A. FIGS. 2A-2C validate the measurements shown in Table 2 and the improved plant growth achieved by applying to the soil mixed with water as a soil drench.

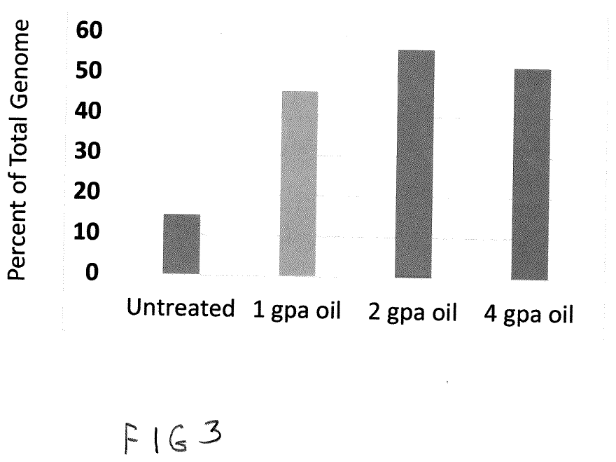

FIG. 3 is a graph that reflects the relative genome presence of PGPR bacteria in untreated tomato seedlings and seedlings treated with one, two and four gallons biofertilizer per acre respectively. The concentration of beneficial bacteria in the rhizosphere of the plant treated is almost 60% of the total genome of bacteria, whereas the prevalence of such bacteria for the untreated plant is only 15% of the total bacterial genome. This is evidence that significantly increased populations of PGPR bacteria result following the application of the biofertilizer to the plant medium in accordance with this invention.

Accordingly, applying formulations of the biofertilizer to soil and other growing media as described herein dramatically increases the population of beneficial PGPR and other beneficial bacteria and fungi, which, in turn, significantly enhances and improves plant growth and resultant crop yields. Applying a biofertilizer based principally on liquid hydrocarbons either alone or in combination of the components described herein, to the soil or other growing media is novel technology and there is no prior art. Petroleum-based oils in the soil are widely deemed to be harmful and not appropriate for applying to crops. In particular, the chemical benzene, a constituent of most oil/petroleum hydrocarbon products, has a fairly complex chemical ring structure that is toxic and would never intentionally or purposely be applied to crops. Conversely, we have determined that purified hydrocarbons that are largely free of aromatic chemical constituents and other contaminants and undesirable components, and which consists of biodegradable carbon chemistry is readily consumed by PGPR bacteria, which increases their populations where the biofertilizer is applied. We have determined that the biofertilizer based on purified liquid hydrocarbons serves as an excellent food source to beneficial microorganisms including PGPR bacteria and the fungus Trichoderma. Application of the biofertilizer to the soil or other growing media, either alone or in combination with other additives, favorably manipulates the soil biome to selectively stimulate the population increase of PGPR bacteria and the fungus Trichoderma. This, in turn, contributes significantly to the improved crop growth and yield described herein, and decreases the incidence of plant disease including post-harvest diseases.

The formulation and process of this invention provides significant benefits to the agricultural industry. By utilizing the described biofertilizer, an increase in the presence of PGPR bacteria results, which, in turn, improve plant growth and crop production. Furthermore, a reduced reliance upon nitrogen and other chemical fertilizers is achieved. This provides both environmental and cost benefits. In addition, the problems of expense and scale encountered when adding traditional organic amendments are also avoided, as are the challenges posed by attempting to increase carbon sequestration in the soil.

Accordingly, the present invention relates to a method for applying a biofertilizer based on mixtures of liquid hydrocarbons and other components such as soil bacteria, metal chelating agents, surfactants, and emulsifying agents to increase plant growth, crop production and yield, and plant disease reduction. While this detailed description has set forth particularly preferred embodiments of this invention, numerous modifications and variations of the composition, elements and steps of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

1. A method of treating at least one of a plant growing media and plants grown in that media to improve crop growth and yield, and resistance to plant disease including post-harvest disease, said method comprising:
providing a biofertilizer that includes paraffinic mineral oil (PMO); and
applying said biofertilizer to at least one of the plant growing media and plants grown in that media at a rate sufficient to increase the population of plant growth promoting microorganisms in the plant growing media.

2. The method of claim 1 in which said biofertilizer is applied at a rate of at least 0.5 gallons per acre and not more than 5 gallons per acre of the planting media.

3. The method of claim 1 in which said biofertilizer is applied monthly at a rate of at least 1 gallon per acre and not more than 2 gallons per acre of the planting media.

4. The method of claim 1 in which said biofertilizer includes at least one of the group comprising liquid hydrocarbons, metal-chelating agents, soil microbes and emulsifying agents.

5. The method of claim 1 in which said biofertilizer is co-applied either simultaneously, or sequentially, with at least one of a pre-plant soil fumigant, a bio-stimulant and a fertilizer.

6. The method of claim 1 in which said biofertilizer is applied with water.

7. The method of claim 1 in which said biofertilizer is applied by at least one of the group comprising irrigation, pre-plant spraying, post-plant spraying, mixing, subsurface knifing, lay by application, side dress application, furrow application, hydroponically, soil drenching and injection.

8. The method of claim 1 in which a fumigant is applied with said biofertilizer to the plant growing media before crops are planted in the growing media and wherein said PMO has a concentration of 1%-50% by weight of said fumigant.

9. A biofertilizer for applying to at least one of a plant growing media and plants grown in the plant growing media to improve plant growth and yield and resistance to plant disease including post-harvest diseases, said biofertilizer comprising:
a liquid hydrocarbon composition which includes paraffinic mineral oil for increasing the population of plant growth promoting microorganisms in the plant growing media; and
at least one constituent from the group including plant growth-promoting microorganisms, metal-chelating agents and emulsifying agents.

10. The composition of claim 9 in which said metal-chelating agents include hydroxybenzyl ethylenediamine.
